(19) United States
(12) Patent Application Publication
(10) Pub. No.: US 2014/0333538 A1
(43) Pub. Date: Nov. 13, 2014

(54) INPUT DEVICE AND CONFIGURATION SETTING SYSTEM THEREOF

(71) Applicant: DEXIN CORPORATION, New Taipei City (TW)

(72) Inventor: YUAN-JUNG CHANG, NEW TAIPEI CITY (TW)

(73) Assignee: Dexin Corporation, New Taipei City (TW)

(21) Appl. No.: 13/892,245

(22) Filed: May 11, 2013

(51) Int. Cl. G06F 3/0354

(52) U.S. Cl. CPC G06F 3/03543
USPC 345/163

(57) ABSTRACT

A configuration setting system of an input device comprises an input device and a mobile device. The input device comprises a first wireless transceiver unit, a first control unit and at least a first operating unit. The first wireless transceiver unit receives a setting signal from mobile device. The first control unit is electrically coupled to first wireless transceiver unit and the first operating unit. The first control unit controls operation setting of the first operating unit. The mobile device comprises a second wireless transceiver unit and is installed with a setting configuration program corresponding to input device. The mobile device transmits wirelessly a setting signal via second wireless transceiver unit according to the setting configuration program. The input device receives the setting signal via the first wireless transceiver unit such that first control unit of the input device performs an operation setting according to the setting signal.

### BACKGROUND OF THE INVENTION

1. Field of the Invention

The present invention relates to an input device; in particular, to an input device and a configuration setting system thereof.

2. Description of Related Art

In modern society, computer and life are closely related, and completion of many works must depend on the operation of computers. In addition, as for amusement, a computer may be used by a user to perform an electronic game when the user is at leisure. When a user performs an electronic game, usually input devices such as a mouse and a keyboard must be used to control the performance of the game. In a game, in order to let a user operate more conveniently and faster a fast instruction corresponding to the game, a multi-key mouse is thus produced. The multi-key mouse means that the surface of a mouse is provided with four or more multi-functional keys. Before a user wishes to use a multi-key mouse, usually a software drive program attached by a firm must be collocated to perform a related installation procedure. In an installation procedure, the software drive program usually provides a graphical operation interface, so as to let a user set by him/herself a specific key that is equivalent to a specific combination function or instruction.

However, when the software drive program is installed, a user usually must close an opened application program or document, and the user is forced to close all the working windows that are performed at present, thus some inconveniences of a user are caused invisibly. In addition, in an installation procedure, a compatibility problem may be occurred owing to the manager authority of a computer host or relation of antivirus software misjudgement, thus the installation cannot be performed smoothly. At the same time, after the key-operation setting of a multi-key mouse has been finished, an installation procedure identical to the above description must be performed if the multi-key mouse whose key-operation setting has been finished will be used for a different computer host. In this manner, the multi-key mouse shows a significant complexity when a computer host is installed.

### SUMMARY OF THE INVENTION

The object of the present invention is to provide an input device and a configuration setting system thereof, wherein the setting configuration program of an input device is installed in a mobile device, and a first transceiver unit having an ability of wireless transmitting and delivering is disposed on the input device, such that the mobile device can perform an operation setting for the input device, thus the installation complexity of the input device can be simplified.

The present invention provides an input device, and the corresponding setting configuration program thereof is installed in a mobile device. The input device comprises a first wireless transceiver unit, a first control unit and at least a first operating unit. The first wireless transceiver unit receives a setting signal sent out from the mobile device. The first control unit is electrically connected with the first wireless transceiver unit and the first operating unit. The first control unit controls the operation setting of the first operating unit. The first control unit sets the operation setting of the first operating unit according to a setting signal.

The present invention provides a configuration setting system of an input device, and comprises an input device and a mobile device. The input device comprises a first wireless transceiver unit, a first control unit and at least a first operating unit. The first wireless transceiver unit receives a setting signal sent out from the mobile device. The first control unit is electrically connected with the first wireless transceiver unit and the first operating unit. The first control unit controls the operation setting of the first operating unit. A setting configuration program corresponding to the input device is installed in the mobile device. The mobile device comprises a second wireless transceiver unit. The mobile device transmits wirelessly a setting signal via the second wireless transceiver unit according to a setting configuration program. The input device receives the setting signal via the first wireless transceiver unit, such that the first control unit of the input device performs an operation setting according to the setting signal.

Summing up the above, as for the input device and configuration setting system thereof provided in the embodiment of the present invention, a setting configuration program corresponding to the input device is installed in the mobile device, and a first wireless transceiver unit is disposed on the input device. Thus, the mobile device can perform directly an operation setting for the input device by means of the installed setting configuration program, so it is not necessary to set a computer host when the related operation setting of the input device is performed.

In order to further the understanding regarding the present invention, the following embodiments are provided along with illustrations to facilitate the disclosure of the present invention. However, the description and drawings are merely provided for reference and illustration, without any intention to be used for limiting the present invention.

### BRIEF DESCRIPTION OF THE DRAWINGS

FIG. 1A shows a schematic diagram of an input device according to an embodiment of the present invention;

FIG. 1B shows a block diagram of an input device according to an embodiment of the present invention;

FIG. 2A shows a schematic diagram of a configuration setting system of the input device according to an embodiment of the present invention;

FIG. 2B shows a block diagram of a mobile device according to an embodiment of the present invention;

FIG. 3A shows a setting interface of a mobile device for the input device according to an embodiment of the present invention;

FIG. 3B shows a keying setting interface of a mobile device according to an embodiment of the present invention;

FIG. 3C shows a sensitivity setting interface of a mobile device according to an embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objects and advantages related to the present invention will be illustrated in the subsequent descriptions and appended drawings.

### Embodiment of an Input Device and a Configuration Setting System Thereof

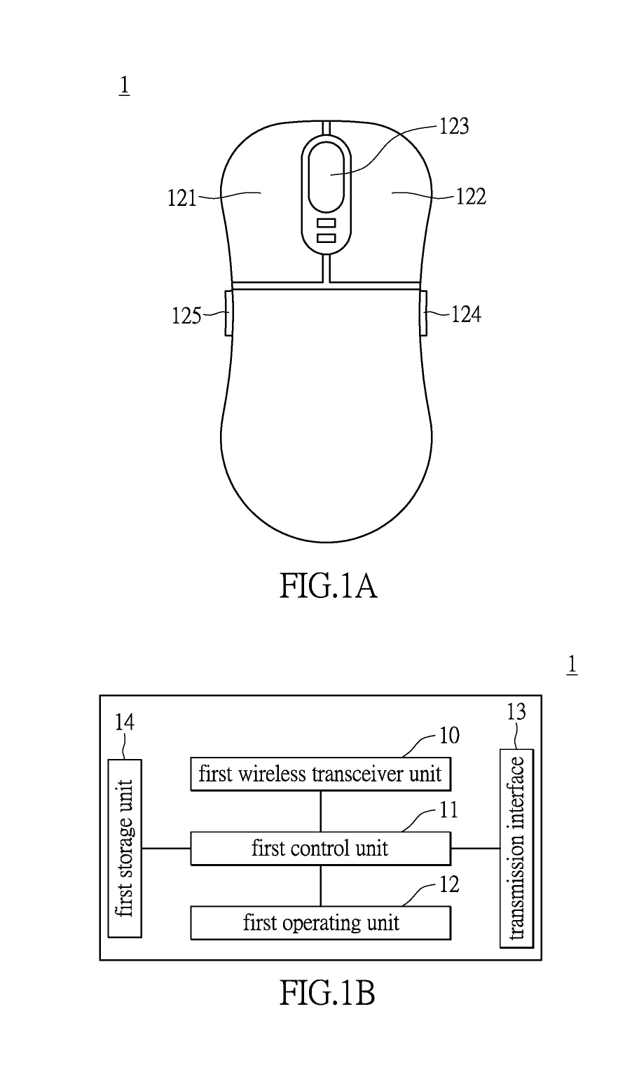

Please refer to FIG. 1A and FIG. 1B simultaneously. FIG. 1A shows a schematic diagram of an input device according to an embodiment of the present invention. FIG. 1B shows a block diagram of an input device according to an embodiment of the present invention. The input device 1 comprises a first wireless transceiver unit 10, a first control unit 11, at least a first operating unit 12, a transmission interface 13 and a first storage unit 14. The first operating unit 12 comprises a left key 121, a right key 122, a roller 123, a fourth key 124 and a fifth key 125. In the present embodiment, the input device may be a mouse or a keyboard, a game joystick etc. A mouse is used for illustration in the present embodiment. The type of the input device is not limited in the present embodiment. As shown in FIG. 1B, the first control unit 11 is electrically connected with the first wireless transceiver unit 10, the first operating unit 12, the transmission interface 13 and the first storage unit 14 respectively. The first operating unit 12 may be a key, a roller, a slide switch or an electronic switch. The first wireless transceiver unit 10 may be a Bluetooth unit, a Zigbee unit or a WiFi unit. The transmission interface 13 may be a wireless transmission interface or a wired transmission interface, i.e., the input device 1 may be connected wirelessly or wiredly with the computer host.

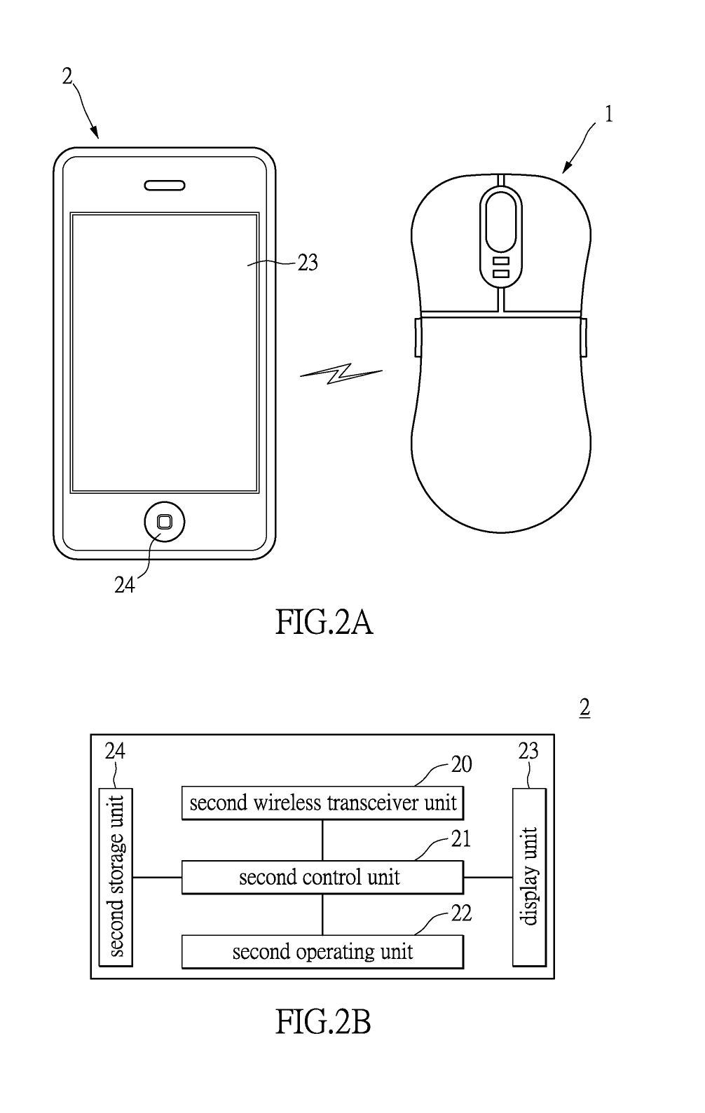

Please refer to FIG. 2A and FIG. 2B simultaneously. FIG. 2A shows a schematic diagram of a configuration setting system of the input device according to an embodiment of the present invention; FIG. 2B shows a block diagram of a mobile device according to an embodiment of the present invention. As shown in FIG. 2A, the configuration setting system of the input device comprises an input device 1 and a mobile device 2. As shown in FIG. 2B, the mobile device 2 comprises a second wireless transceiver unit 20, a second control unit 21, a second operating unit 22, a display unit 23 and a second storage unit 24. In the present embodiment, the mobile device 2 may be a handset, a Personal Digital Assistant (PDA) or a tablet computer. The type of the mobile device is not limited in the present embodiment. As shown in FIG. 2B, the second control unit 21 is electrically connected with the second wireless transceiver unit 20, the second operating unit 22, the display unit 23 and the second storage unit 24 respectively. The second wireless transceiver unit 20 is identical to the first wireless transceiver unit 10 and may be a Bluetooth unit, a Zigbee unit or a WiFi unit, too. The display unit 23 may be a touch display panel. The second storage unit 24 may be either a memory, built in the mobile device 2, or an external memory card.

Please refer to FIG. 1A, FIG. 1B, FIG. 2A and FIG. 2B simultaneously. The second storage unit 24 of the mobile device 2 stores a setting configuration program corresponding to the input device 1. According to the setting configuration program stored in the second storage unit 24, the second control unit 21 can control the display unit 23 to display a setting interface corresponding to the input device 1. A user performs an operation setting of the input device 1 by means of operating a setting interface, wherein the operation setting is a keying setting or a sensitivity setting related to the input device 1. To describe further, when a user performs an operation setting of the input device 1 by means of operating a setting interface, the mobile device 2 will correspondingly send a setting signal via the second wireless transceiver unit 20. Next, the input device 1 receives the setting signal via the first wireless transceiver unit 10, and transmits the setting signal to the first control unit 11. Thus, the first control unit 11 may correspondingly change the operation setting of the input device 1 according to the setting signal, and stores the operation setting into the first storage unit 14 of the input device 1, so as to finish the operation setting of the input device 1. Thus, the operation setting of the input device 1 may be finished under a condition that a computer host is not necessary to be passed through.

In addition, when the mobile device 2 is installed with the setting configuration program of the input device 1, the second control unit 21 of the mobile device 2 may be linked to a remote database automatically via a network by means of the second wireless transceiver unit 20, and the setting information corresponding to the input device 1 is downloaded to the second storage unit 24. Of course, a user may let the mobile device 2, in which the setting configuration program corresponding to the input device 1 is installed, operate either the second operating unit 22 or the display unit 23 having a touch function, then the mobile device 2 selectably transmits an operation instruction to the second control unit 21, and is linked to a remote database via a network by means of the second wireless transceiver unit 20, thereafter downloading of the setting information begins to be performed. In this manner, the mobile device 2 may update at any time the setting configuration program of the input device 1, and compatibility problem of either antivirus software misjudgement or insufficiency of access right, which may occur when a computer host is installed with the setting configuration program of the input device, can be avoided.

To describe further, when the input device 1 is a keyboard, another multi-key mouse, or a game joystick and the second storage unit 24 of the mobile device 2 is not installed with a corresponding setting configuration program, the user may operate either the second operating unit 22 or the display unit 23 having a touch function, then the mobile device 2 is linked to a remote database via a network by means of the second wireless transceiver unit 20, so as to perform the downloading of the corresponding setting configuration program. In this manner, when the input device 1 is an input device of different type, the mobile device 2 may perform the downloading of the setting configuration program via the remote database, such that the mobile device 2 can perform an operation setting for an input device of different type.

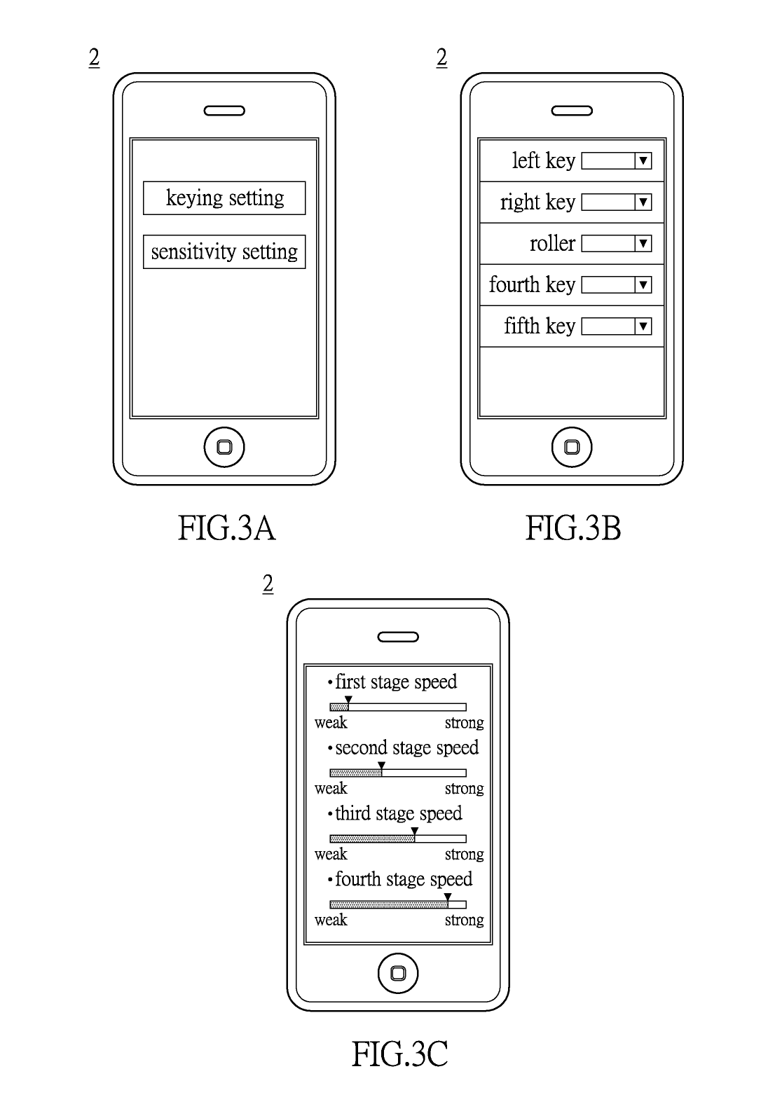

Please refer to FIG. 3A, FIG. 3B and FIG. 3C simultaneously. FIG. 3A shows a setting interface of a mobile device for the input device according to an embodiment of the present invention. FIG. 3B shows a keying setting interface of a mobile device according to an embodiment of the present invention. FIG. 3C shows a sensitivity setting interface of a mobile device according to an embodiment of the present invention. The second control unit 21 of the mobile device 2 controls the display unit 23 to display the setting interface according to the setting configuration program stored in the second storage unit 24. As shown in FIG. 3A, the setting interface shows some graphical keys such as a keying setting and a sensitivity setting etc. However, the category of the graphical key shown by the setting interface is not limited in the present embodiment, i.e., the setting interface may further show a graphical key having a feature setting, such as a mouse lamp display mode or macro editing etc. When a user presses “the keying setting” to set the graphical key, the user may set a configuration personally. As shown in FIG. 3B, the display unit 23 may display a keying setting interface. In the keying setting interface, a left key 121, a right key 122, a roller 123, a fourth key 124, and a fifth key 125 corresponding to the input device 1 are displayed, and a pull-down menu exists respectively at the right side of the left key 121, the right key 122, the roller 123, the fourth key 124, and the fifth key 125. A user may perform a setting of keying function according to personal requirement, wherein the pull-down menu may be, for example, speed switching, simulating a keyboard, or mouse click delay time etc. (not shown). The content of the pull-down menu is not limited in the present invention. When a user presses the “sensitivity setting” to set the graphical key, as shown in FIG. 3C, the second storage unit 24 will display the sensitivity setting interface, so as to let the user set the sensitivity of the input device 1. For example, resolution of a mouse cursor is set. In the present embodiment, the sensitivity setting interface only displays a setting of four stage speeds, which are first stage speed, second stage speed, third stage speed and fourth stage speed. However, the stage amount used by the input device 1 is not limited in the present embodiment.

### Possible Efficacy of Embodiments

According to the input device and the configuration setting system thereof in the embodiment of the present invention, the input device can be directly set by means of a mobile device in which the setting configuration program corresponding to the input device is installed, and the setting configuration program corresponding to the input device can be downloaded or updated via a network. Thus, a user can perform an operation setting for the input device by means of a mobile device, so as to simplify the complexity when a user performs a drive program installation of the input device in a computer host or avoid the compatibility problem between a host and the setting configuration program.

The descriptions illustrated supra set forth simply the preferred embodiments of the present invention; however, the characteristics of the present invention are by no means restricted thereto. All changes, alterations, or modifications conveniently considered by those skilled in the art are deemed to be encompassed within the scope of the present invention delineated by the following claims.

What is claimed is:

1. An input device, used for installing a setting configuration program corresponding thereto into a mobile device, the input device comprising:
a first wireless transceiver unit, receiving a setting signal sent out from the mobile device;
at least a first operating unit; and
a first control unit, electrically connected with the first wireless transceiver unit and the first operating unit, wherein the first control unit controls an operation setting of the first operating unit, and the first control unit sets the operation setting of the first operating unit according to the setting signal.

2. The input device according to claim 1, wherein the input device further comprises a transmission interface, which is a wireless transmission interface or a wired transmission interface.

3. The input device according to claim 1, wherein the input device is a mouse, a keyboard or a game joystick.

4. The input device according to claim 1, wherein the first operating unit is a key, a roller, a slide switch or an electronic switch.

5. The input device according to claim 1, wherein the input device further comprises a first storage unit electrically connected with the first control unit, wherein the first storage unit is used for storing the operation setting.

6. The input device according to claim 1, wherein the operation setting is a keying setting or a sensitivity setting.

7. A configuration setting system of an input device, comprising:
an input device, comprising:
a first wireless transceiver unit, receiving a setting signal at least a first operating unit; and
a first control unit, electrically connected with the first wireless transceiver unit and the first operating unit, wherein the first control unit controls an operation setting of the first operating unit, and
a mobile device, comprising a second wireless transceiver unit, wherein a setting configuration program corresponding to the input device is installed in the mobile device.
wherein the mobile device transmits wirelessly the setting signal via the second wireless transceiver unit according to a setting configuration program, the input device receives the setting signal via the first wireless transceiver unit, such that the first control unit of the input device performs the operation setting according to the setting signal.

8. The configuration setting system of the input device according to claim 7, wherein the operation setting is a keying setting or a sensitivity setting.

9. The configuration setting system of the input device according to claim 7, wherein the mobile device is a smart handset, a Personal Digital Assistant (PDA) or a tablet computer.

10. The configuration setting system of the input device according to claim 7, wherein the first wireless transceiver unit or the second wireless transceiver unit is a Bluetooth unit, a Zigbee unit or a WiFi unit.

11. The configuration setting system of the input device according to claim 7, wherein the mobile device further comprises a second storage unit, which is used for storing the setting configuration program.

12. The configuration setting system of the input device according to claim 7, wherein the mobile device is linked to a remote database via a network so as to download the setting configuration program corresponding to the input device into the second storage unit.
